(19) United States
(12) Patent Application Publication
(10) Pub. No.: US 2007/0278378 A1
(43) Pub. Date: Dec. 6, 2007

(54) Flow-through concrete edge forming system and method

(76) Inventor: James C. Sullivan, DeFuniak Springs, FL (US)

Correspondence Address: Peter Loffler, P.O. Box 1001, Niceville, FL, 32588-1001, US

(21) Appl. No.: 11/446,049

(22) Filed: Jun. 5, 2006

(51) Int. Cl. B29C 33/00

(52) U.S. Cl. 249/187.1

(57) ABSTRACT

A flow-through concrete edge forming system utilizes a body member that has perforations thereon. The body member is placed at an elevation transition area of a monolithic slab as an edge forming form. Once the slab is poured, a parge coating is placed on the outer surface of the body member such that the parge coating either binds to the outer surface or penetrates the body member through a series of perforations on the body member in order for the parge coating to bind with the concrete of the slab which has yet to set thereby producing a clean and solid finish of the outer surface of the slab at the transition area. The body member may have either a rectangular profile, a keyhole profile or may have the perforations on a series of inwardly directed deformations.

### BACKGROUND OF THE INVENTION

1. Field of the Invention

The present invention relates to a concrete edge forming system and method for its use that are used for monolithic slab formations that have an elevation change wherein the components of the system are left in place after the slab is poured.

2. Background of the Prior Art

A basic monolithic slab foundation is a relatively straightforward construction item to produce. The foundation is measured out and formed up, typically using wooden forms. If necessary, rebar reinforcements are positioned and the concrete is poured and finished as desired. For many a building, this process is sufficient. However, other buildings have one or more elevation changes at various locations of the slab. For example, a house may have a sunken living room, steps may be required, or a porch has a slight drop down. In all such situations, the slab has an elevation change which requires a transition area.

Typically, to form a monolithic slab with an elevation change, the outer perimeter of the slab is formed in standard fashion. At the interior transition site additional interior forms are used in order to separate the concrete that will be poured at the higher elevation from violating the region of the lower elevation of the slab. The current formation method calls for the depressed portions of the slab to be poured at a later time because the initial formwork bracing is situated in the depressed slab area and must be removed to keep from interfering with the pouring of concrete in the depressed slab area. Having to come back at a later date to pour the depressed sections of the slab, increases the production costs and as well as the slab completion time.

Accordingly, there exists a need in the art for a concrete forming system that is used for a monolithic slab which slab has one or more elevation changes. Such a system must be relatively easy to use and be labor efficient so as not to unduly increase the costs of forming this type of slab, nor increase the time required to complete the slab. Such a system must allow the exposed face of the slab at the site of elevation transition to be able to be finished to a high degree of aesthetic quality with minimal possibility for finish failure.

### SUMMARY OF THE INVENTION

The flow-through concrete edge forming system and method of the present invention addresses the aforementioned needs in the art. The flow-through concrete edge forming system is a concrete forming system that is used at the elevation transition areas of monolithic slabs and that is designed-to remain in place after the slab is finished. The flow-through concrete edge forming system is relatively easy to use and does not require unproductive time demands on a finisher by removing the need for the finisher to return subsequent to the-initial finish time. The flow-through concrete edge forming system and method allow the finisher to be able to aesthetically finish the exposed face of the transition area of the slab prior to concrete set in order to be able to produce an attractive finished surface that is not prone to fail over time due to inadequate bond. The present invention allows for all components of the formwork to be left in the slab after concrete pour so that the bracing or the formwork doesn't interfere with the finishing of the depressed sections. This permits pouring of all slab sections without interruption. In addition, grout fills the voids in the form and allows a bonding surface for future aesthetic treatments. The flow-through concrete edge forming system can also be used as a “left-in-place” screed system, cold joint break, and slab keying system.

The flow-through concrete edge forming system and method of the present invention are comprised of an elongate body member that has a first section with a first series of perforations thereon. The body member is placed at an elevation change transition area of the slab to be poured in order to form that area up. The slab is poured and the body member is maintained at the transition area after the pour. The body member may have a second section with a second series of perforations, the second section being separated from the first section by a bridge. The first series of perforations are located on an inwardly directed first deformity and the second series of perforations are located on an inwardly directed second deformity. A flange extends downwardly from the body member and has at least one bend line formed thereon. The body member may a keyhole profile instead of the inwardly directed deformations or may have a rectangular profile. A lip may be located on the body member such that the lip serves as a weld point whenever the body member is welded to another structure.

### BRIEF DESCRIPTION OF THE DRAWINGS

FIG. 1 is a perspective view of the flow-through concrete edge forming system and method of the present invention.

FIG. 2 is a sectional view of the flow-through concrete edge forming system and method taken along line 2-2 in FIG. 1.

FIG. 3 is a perspective view of the flow-through concrete edge forming system and method in place within a slab to fashion a depression within the slab.

FIG. 4 is a perspective view of a first alternate embodiment of the flow-through concrete edge forming system and method of the present invention.

FIG. 5 is a sectional view of the first alternate flow-through concrete edge forming system and method taken along line 5-5 in FIG. 4.

FIG. 6 is a perspective view of a rebar bracket that can be used with the flow-through concrete edge forming system and method of the present invention.

FIG. 7 is a perspective view of an end bracket that can be used with the flow-through concrete edge forming system and method of the present invention.

FIG. 8 is a perspective view of an angle bracket that can be used with the flow-through concrete edge forming system and method of the present invention.

FIG. 9 is a perspective view of a second alternate embodiment of the flow-through concrete edge forming system and method of the present invention.

FIG. 10 is a sectional view of the second alternate flow-through concrete edge forming system and method taken along line 10-10 in FIG. 9.

FIG. 11 is a perspective view of the second alternate embodiment of the flow-through concrete edge forming system and method having perforations.

FIG. 12 is a sectional view of the second alternate embodiment of the flow-through. concrete edge forming system and method taken along line 12-12 in FIG. 11.

FIG. 13 is a detail view of the second alternate embodiment of the flow-through concrete edge forming system and method taken along ellipse 13 in FIG. 11.

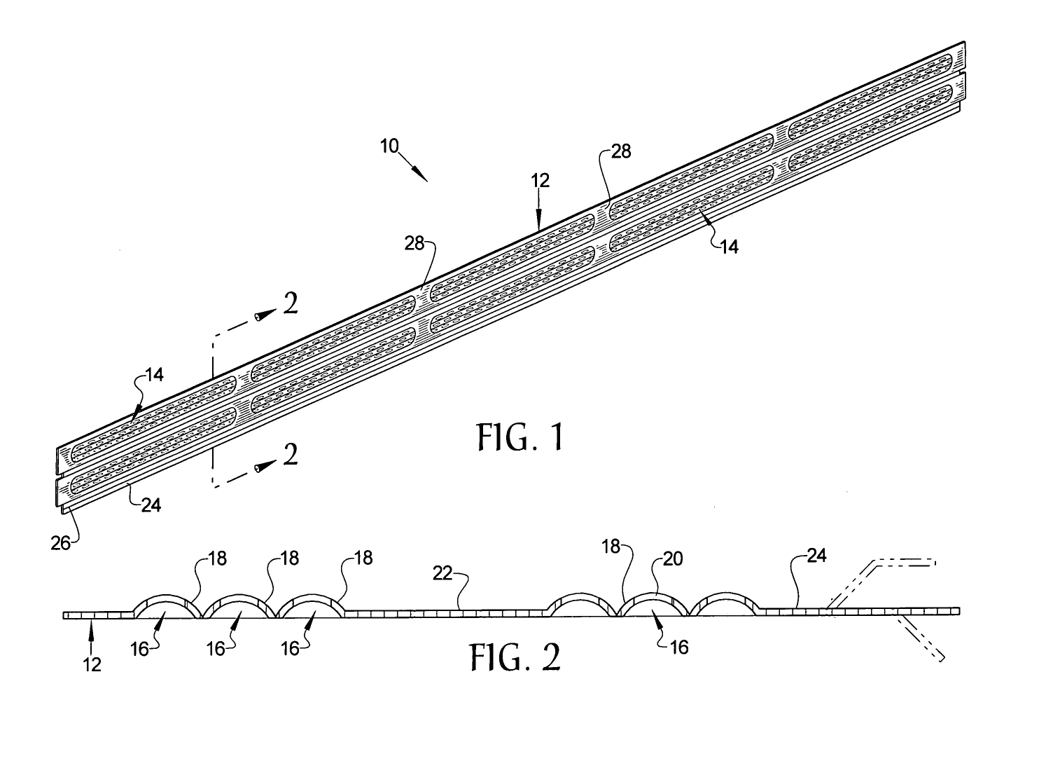

Similar reference numerals refer to similar parts throughout the several views of the drawings.

### DESCRIPTION OF THE PREFERRED EMBODIMENT

Referring now to the drawings, it is seen that the flow-through concrete edge forming system and method of the present invention, generally denoted by reference numeral 10, are comprised of an elongate body member 12 that has one or more sections 14, each section 14 having one or more rows 16 of inwardly directed deformities 18. Each deformity 18 has a series of perforations 20 located thereon. Each section 14 is separated from other sections 14 by a neck 22. A lower flange 24 extends downwardly from the lowermost section 14 and has one or more longitudinal bend lines 26 formed thereon to enable the flange 24 to be bent, with relative ease, either inwardly or outwardly as desired during form set. A series of bridges 28 are located along the length of the body member 12 in order to horizontally separate adjoining sections 14 in order to give the body member 12 added structural integrity along its length. The height of the body member 12 can be any desired height although various standard sizes such as four inches, one inch, two inches, and six inches may prove efficient, although heights outside of these parameters are within the scope and spirit of the present invention. The length of each body member 12 may also be of any desired length, although lengths on the order of about ten feet may prove advantageous from a shipping and handling perspective. The body member 12 may be of monolithic construction and may be made from stamped sheet metal having a galvanized coating. Body members 12 made from stainless steel, plastic, etc., are also anticipated.

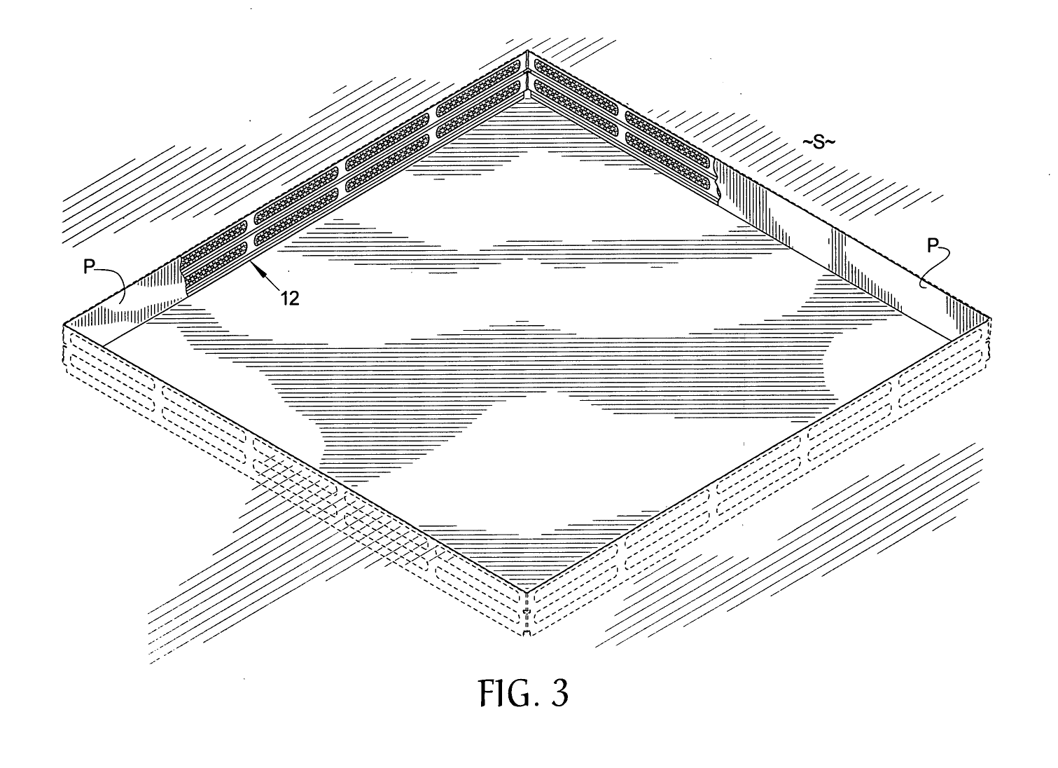

In order to use the flow-through concrete edge forming system and method 10 of the present invention, the body member 12 is positioned in the usual way at the elevation transition area of the slab S to be poured. Various brackets such as rebar brackets 30, end brackets 32, and angle brackets 34 are used in the usual way with the body member 12. If several body members 12 are positioned angularly relative to one another, such as the rectangular layout illustrated in FIG. 3, the body members 12 are joined to one another in any appropriate fashion such as weld joining, etc. Once the slab S is poured, the body members 12 act as forms in the usual way. Prior to the setting of the concrete of the slab S, a parge coating P is formed on the outwardly facing side of the body member 12. The perforations 20 on the body member 12 allow the parge coating P to penetrate the body member 12 to the slab S in order to the parge coating P to bind with the remainder of the slab S assuring a solid and attractive finish. Once the slab S and the parge coating P are set, all components of the invention 10, including the body members 12, the rebar brackets 30, if used, the end brackets 32, if used, and the angle brackets 34, if used, remain within the set slab S. These elements do not detract from the structural strength or integrity of the slab S.

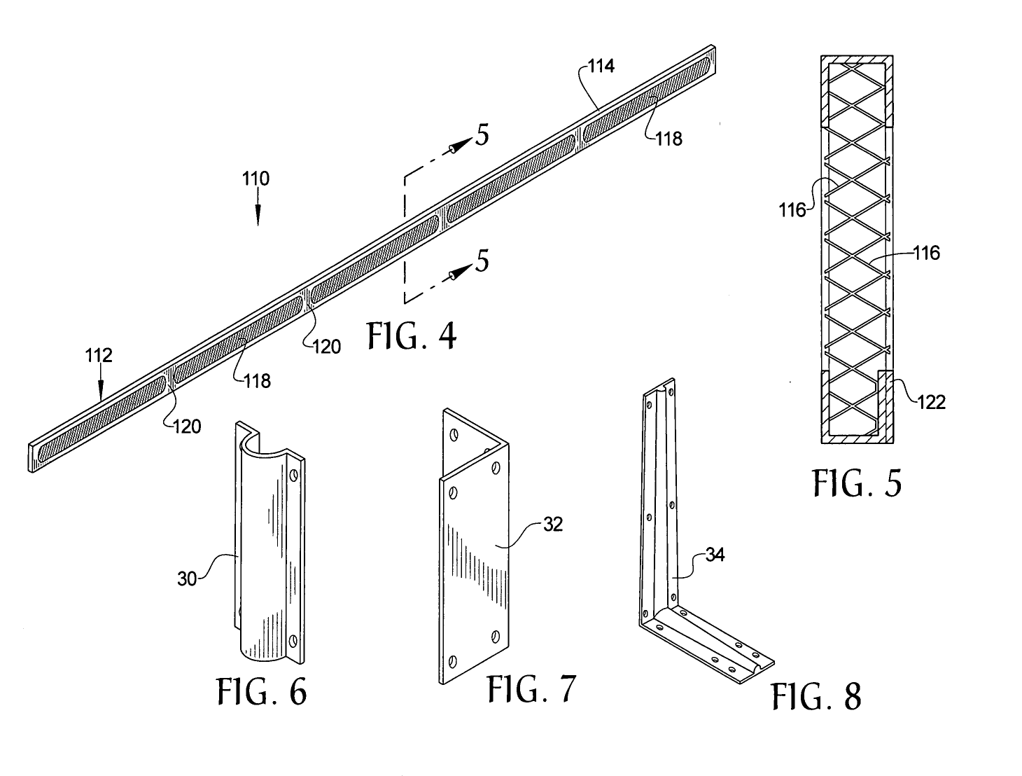

As seen in FIGS. 4 and 5, an alternate embodiment of the flow-through concrete edge forming system and method 110 of the present invention uses a body member 112 having a rectangular cross-section and with an outer metal form 114 and a series of internal cross bars 116 that form the perforations 118 of the body member 112. A series of bridges 120 extend between the top and the bottom of the outer metal form 114 at various positions along the length of the body member 112 for added structural integrity of the body member 112 along its length. An overlapping lip 122 formed on the outer metal form 114 provides a weld point area for joining one body member 112 to another. This first alternate embodiment of the flow-through concrete edge forming system 110 is used in the same fashion as the previous embodiment 10. The height of the body member 112 can be any desired height although various standard sizes such as four inches, one inch, two inches, and six inches may prove efficient, although heights outside of these parameters are within the scope and spirit of the invention. The length of each body member 112 may also be of any desired length, although lengths on the order of about ten feet may prove advantageous from a shipping and handling perspective. The body member 112 may but need not be of monolithic construction and may be made from stamped sheet metal having a galvanized coating. Body members 112 made from stainless steel, plastic, etc., are also anticipated.

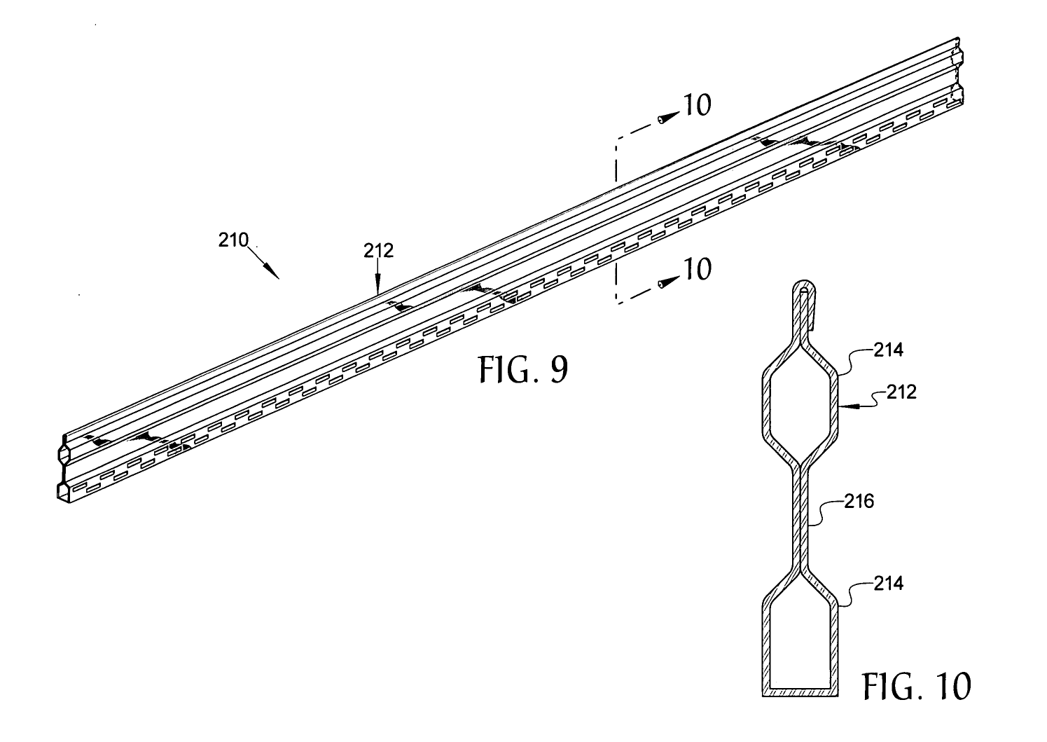

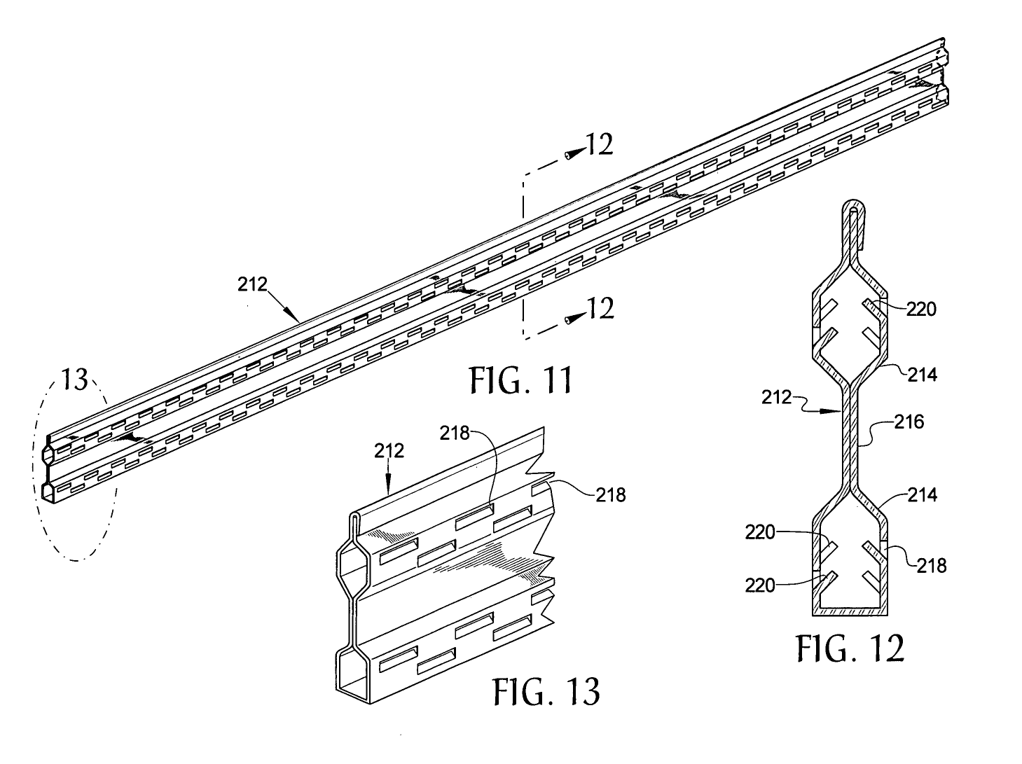

As seen in FIGS. 9-13, a second alternate embodiment of the flow-through concrete edge forming system and method 210 of the present invention uses a body member 212 that has one or more key hole profiles 214, each key hole profile 214 separated by a neck 216. In this embodiment 210, the parge coating P can be adhered to the outer surface of the body member 212 with the transitions between the key hole profiles 214 and the necks 216 providing a change in depth for the parge coating P allowing for a solid bind or, as seen in FIGS. 11-13, each key hole profile 214 can have a series of perforations 218 thereon to allow the parge coating P to penetrate the body member 212 and bind with the remainder of the slab S. The perforations 218 can be punched into the key hole profile 214 such that the tails 220 remain within the key hole profile 214 after the punch. The body member 212 wherein the key hole profiles 214 have perforations 218 therein is utilized in the same fashion as the previous embodiments 10 and 110 of the flow-through concrete edge forming system. The height of the body member 212 can be any desired height although various standard sizes such as four inches, one inch, two inches, and six inches may prove efficient, although heights outside of these parameters are within the scope and spirit of the invention. The length of each body member 212 may also be of any desired length, although lengths on the order of about ten feet may prove advantageous from a shipping and handling perspective. The body member 212 may be of monolithic construction and may be made from stamped sheet metal having a galvanized coating. Body members 212 made from stainless steel, plastic, etc., are also anticipated.

While the invention has been particularly shown and described with reference to embodiments thereof, it will be appreciated by those skilled in the art that various changes in form and detail may be made without departing from the spirit and scope of the invention.

I claim:

1. A form for forming a monolithic concrete slab having a depression at a transition area, the form comprising an elongate body member having a first section with a first series of perforations wherein the body member is placed at the transition area and maintained thereat after an amount of concrete is poured to construct the slab.

2. The form as in claim 1 wherein the first series of perforations are located on an inwardly directed deformity.

3. The form as in claim 1 wherein the body member has a second section with a second series of perforations, the second section separated from the first section by a bridge.

4. The form as in claim 3 wherein the first series of perforations are located on an inwardly directed first deformity and the second series of perforations are located on an inwardly directed second deformity.

5. The form as in claim 1 further comprising a flange extending downwardly from the body member, the flange having a bend line formed thereon.

6. The form as in claim 1 wherein the body member has a keyhole profile.

7. The form as in claim 1 wherein the body member has a rectangular profile.

8. The form as in claim 7 wherein the body member has a lip for welding the body member to another structure.

9. A method of forming a monolithic concrete slab having a depression at a transition area, the method comprising the steps of:
providing an elongate body member having a first section with a first series of perforations;
placing the body member at the transition area;
pouring the slab; and
maintaining the body member at the transition area after the slab is poured.

10. The method as in claim 9 wherein the first series of perforations are located on an inwardly directed deformity.

11. The method as in claim 9 wherein the body member has a second section with a second series of perforations, the second section separated from the first section by a bridge.

12. The method as in claim 11 wherein the first series of perforations are located on an inwardly directed first deformity and the second series of perforations are located on an inwardly directed second deformity.

13. The method as in claim 9 further wherein a flange extends downwardly from the body member, the flange having a bend line formed thereon.

14. The method as in claim 9 wherein the body member has a keyhole profile.

15. The method as in claim 9 wherein the body member has a rectangular profile.

16. The method as in claim 15 further comprising the steps of:
providing the body member with a lip; and
welding the body member to another structure at the lip.
